(19) United States
(12) Patent Application Publication
(10) Pub. No.: US 2009/0193649 A1
(43) Pub. Date: Aug. 6, 2009

(54) METHOD FOR THE MANUFACTURE OF A THIN FILM ELECTROCHEMICAL ENERGY SOURCE AND DEVICE

(75) Inventors: Rogier Adrianus Henrica Niessen, Eindhoven (NL); Petru Henricus Laurentius Notten, Eindhoven (NL); Freddy Roozeboom, Eindhoven (NL); Franciscus Adrianus Cornelis Maria Schoofs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/306,269

(22) PCT Filed: Jun. 29, 2007
(86) PCT No.: PCT/IB2007/052519

§ 371 Date: Dec. 23, 2008

(30) Foreign Application Priority Data
Jul. 3, 2006 (EP) 06116521.3

(51) Int. Cl. H01M 10/04

(52) U.S. Cl. 29/623.5

(57) ABSTRACT

The invention relates to a method for the manufacture of a thin film electrochemical energy source. The invention also relates to a thin film electrochemical energy source. The invention also relates to an electrical device comprising such a thin film electrochemical energy source. The invention enables a more rapid and efficient manufacture of thin film batteries and devices containing such batteries.

The invention relates to a method for the manufacture of a thin film electrochemical energy source. The invention also relates to a thin film electrochemical energy source. The invention also relates to an electrical device comprising such a thin film electrochemical energy source.

According to the state of the art, the manufacture of thin film batteries comprises the steps of depositing a first electrode layer on a substrate (which is usually not conductive), depositing an electrolyte layer on the first electrode, and depositing a second electrode layer on the electrolyte layer, wherein one of the first electrode layer and the second electrode layer is an anode material and the other electrode is a cathode material. This layer stacking (substrate-anode-electrolyte-cathode or substrate-cathode-electrolyte-anode) can be repeated, in order to yield a serial stack of batteries. Typical depositing methods include chemical and physical vapour deposition techniques as well as sol-gel techniques. After the layers have been deposited, the battery is charged by applying an electric current for some time, until a predetermined charging level of the battery is achieved.

A typical example are lithium ion batteries, consisting of material layers wherein the typical anode material is metallic lithium (Li), and the cathode material is a material such as LiCoO₂. After deposition, the battery is subject to a galvanostatic charging process, in which the battery is charged for use. Charging the battery is a time consuming process. Defects in the battery stack may become apparent after or during charging. Batteries that do not have the required specifications usually have to be discarded.

It is an object of the invention to overcome the disadvantages stated above.

The object of the invention is accomplished by a method for the manufacture of a thin film electrochemical energy source, comprising the steps of depositing a first electrode layer on a substrate, depositing an electrolyte layer on the first electrode, and depositing a second electrode layer on the electrolyte layer, wherein one of the first electrode layer and the second electrode layer is an anode material and the other electrode is a cathode material, characterized in that the anode material and the cathode material are deposited as materials in a charged state, forming a charged battery stack. As the resulting thin film battery is already charged, the process step of charging the battery is omitted, and therefore the method is faster than existing methods. Apart from these basic layers (anode, electrolyte, cathode) that make up the functional battery, additional functional layers may be deposited in between these layers. The product of this method preferably represents a fully charged battery, but may also be partly charged in order to reach the advantages according to the invention. The layer stacking sequence of the battery (substrate-anode-electrolyte-cathode or substrate-cathode-electrolyte-anode) may be repeated in order to yield a stack of battery cells. The battery may be a two-dimensional or three-dimensional layered system. Preferably, the electrochemical energy source is a rechargeable battery system.

Preferably, after depositing at least one electrode layer, at least one electrical characteristic of the formed layer or stack of layers is measured. Electrical characteristics typically include potential and resistance. Thus, defects in the deposited layer or stack of layers may be detected before any further process steps are performed, such as application of an additional layer. If the defect is determined to be larger than a predetermined threshold, the battery may be discarded before any further process steps are performed. Thus, high quality products can be manufactured, as well as an improved efficiency in workflow and the use of materials. With uncharged electrode materials according to the state of the art, external power sources would be needed to check layers for defects, which is much more cumbersome.

Preferably, the method is applied in the manufacture of a device, wherein the functioning of the device is tested during manufacture using power from the assembled thin film electrochemical energy source. Thus, it is relatively easy to check the functioning of the device or device parts and monitor the production step by step. The method enables the timely correction of defects of the device and/or premature removal of defect specimens from the production line. Thus, time and material may be saved, and a more reliable device is obtained. In particular expensive parts, such as microprocessors, may be saved for use in properly working devices rather than devices in which defects where noted during the manufacturing process.

In a preferred embodiment, the device is selected from the group consisting of a lighting device, an implantable device, a hearing aid, a sensor device and a DC/DC convertor. In such devices, reliability is of particular importance.

It is advantageous if the thin film electrochemical energy source is a lithium ion battery, wherein the anode is deposited as a lithium-rich material, and the cathode is deposited as a lithium-deficient material. Lithium ion batteries have a relatively high energy density. Charging a lithium ion rechargeable battery may take considerable time, which is saved by using the method according to the invention. The deposition of lithium-rich anode material or lithium-deficient cathode material may be performed by deposition methods known in the art. The lithium rich anode material may for instance be metallic lithium (Li), lithium-aluminum alloy (Li—Al), or a lithium-tin alloy (Li—Sn), containing a predetermined concentration of lithium. The lithium-deficient cathode material may for instance be Li_{0.1}MnO₂, LiₓNiO₂, LiₓV₂O₅, wherein very low levels of lithium ions are present, typically x=0.1 or lower. The electrolyte layer usually comprises a solid electrolyte containing mobile lithium ions.

Preferably, the lithium-rich anode material is LiₓSi, wherein x ranges from 1 to 4.4. Various deposition methods are suitable to obtain such a layer, however, the most preferred method is the evaporation of predetermined amounts of metallic lithium and elemental silicon under ultra-high vacuum (E-beam deposition).

It is preferred if the lithium-deficient cathode material is Li_{y}CoO₂, wherein y ranges from 0.5-0.6. This material is also conveniently deposited by various methods. A preferred method is sputtering of Li_{y}CoO₂ powder with the desired composition, preferably by DC or RF magnetron sputtering.

The combination of LiₓSi as a lithium-rich anode material and Li_{y}CoO₂ as the lithium-deficient cathode material is especially advantageous.

In another preferred embodiment the thin film electrochemical energy source is a metal hydride battery, wherein the anode is deposited as a metal hydride, and the cathode is deposited as a metal oxyhydroxide. The electrolyte usually comprises a solid electrolyte capable of transporting hydrogen as hydride anions or protons. Various anode electrode materials are suitable, for instance LaNi₅ or MgNi₂. The hydrogen-charged forms of these materials are readily obtained by hydrogenation after the synthesis of the layer, or by reactive sputtering under a hydrogen-argon (H₂/Ar) atmosphere.

It is preferred if the metal hydride is magnesium titanium hydride. Magnesium titanium hydride (MgTiHₓ) is conveniently deposited using for instance evaporation of metallic magnesium and titanium under high vacuum followed by hydrogenation, or by reactive sputtering under a hydrogen-argon (H₂/Ar) atmosphere.

Preferably, the metal oxyhydroxide is nickel oxyhydroxyde. Nickel oxyhydroxyde (Ni(OOH)) is conveniently deposited using for instance by sol-gel deposition methods.

The invention also provides a thin film electrochemical energy source obtainable by the method according to the invention. Such a battery has the advantage that it is ready for use at the moment of assembly. Batteries obtained by quality control of the layers, trough determination of electrical characteristics as described above, have an improved reliability over known batteries. Also, as useless further processing of defect parts is avoided, the cost of batteries according to the invention is lower than known batteries.

The invention further provides an electrical device comprising a thin film electrochemical energy source according to the invention. Such devices have an increased reliability over known devices, due to the improved quality of the battery as well as the monitoring of the assembly of the device using the power of the pre-charged battery during the manufacturing process.

These advantages are most notable for devices in which the thin film electrochemical energy source is integrated in the device.

The invention will now be further elucidated by the following non-limiting examples.

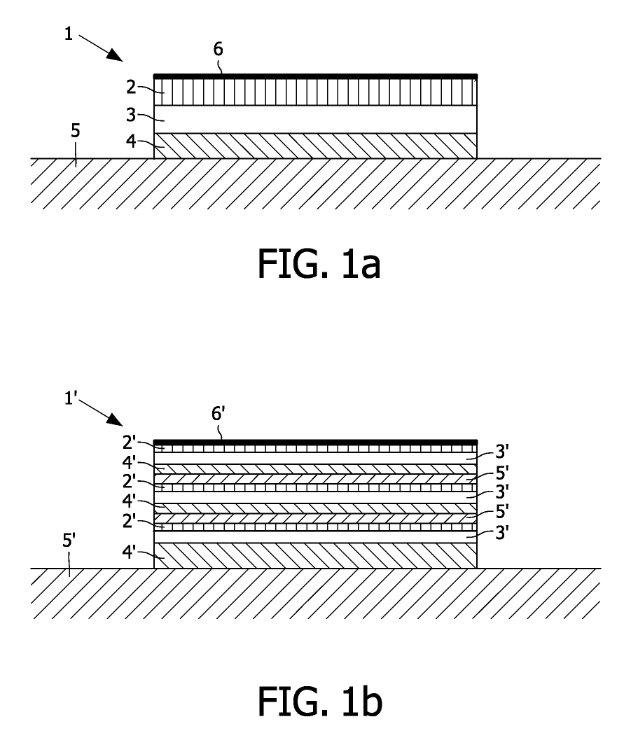

FIGS. 1a and 1b show thin film batteries prepared according to the invention.

FIG. 1a shows a 2-dimensional battery, consisting of an anode layer 2, an electrolyte layer 3 and a cathode layer 4. This battery 1 is prepared by first depositing a cathode material 4 (Li_{0.5}CoO₂) on the substrate 5, followed by an electrolyte layer 3 and the anode material (2) consisting of Li₄Si. The resulting battery is ready to be used, without a charging step. In the state of the art, lithium ions would first have to be electrochemically transferred from the lithium containing cathode material into the anode (Si) layer, resulting in a Li₄Si anode. This extra step is omitted in the method according to the invention, leading to an increased time-efficiency. On top of the stack, a current collector 6 is employed. The relative positions of the anode layer 2 and the cathode layer 4 is arbitrary, and may be reversed without consequences for the production process. The electrical characteristics of the stacked layers can be measured by known techniques.

FIG. 1b is identical to FIG. 1a, with corresponding numbering, but instead the stack 1′ comprises several repeating units as shown in FIG. 1a in series. In the roduction process, the stack 1′ may be checked for defects by measuring electrical characteristics such as resistance. Measurement of electrical characteristics may also be performed when only a part of the stacked layers are deposited, for instance when after the deposition of each cell unit. No external power source is necessary for these checks, as the battery itself is capable of providing the necessary power. If the battery stack does not meet the predetermined requirements, it may be taken out of the production cycle, in order to save further processing steps that would be futile. Thus, time is saved with respect to methods known in the art, where full processing as well as a time-consuming charging step are necessary before any defects in the battery stack become apparent.

In another application, a completed battery, which contains the charged anode and cathode materials, may immediately be used to test a device or device components during manufacture. Thus, defects in an apparatus may be timely detected, and the defects repaired or the defect parts discarded. Such a method is particularly useful in devices wherein the battery is integrated.

For a person skilled in the art, many variations and applications of the invention as presented are achievable.

1. A method for manufacturing a thin film electrochemical energy source, comprising:
depositing a first electrode layer on a substrate,
depositing an electrolyte layer on the first electrode layer, and
depositing a second electrode layer on the electrolyte layer, wherein one of the first electrode layer and the second electrode layer is an anode material and the other electrode layer is a cathode material, the anode material and the cathode material being deposited in a charged state such that a charged battery stack is formed.

2. The method to claim 1, wherein after depositing at least one electrode layer at least one electrical characteristic of the electrode layer or the stack is measured.

3. The method according to claim 1, wherein a thin film electrochemical energy source is included in a device, and an operation of the device is tested during manufacture using a power from the assembled thin film electrochemical energy source.

4. The method according to claim 3, wherein the device is selected from the group consisting of a lighting device, an implantable device, a hearing aid, a sensor device, and a DC/DC converter.

5. The method according to claim 1, wherein the thin film electrochemical energy source is a lithium ion battery, and wherein the anode material is a lithium-rich anode material, and the cathode material is a lithium-deficient cathode material.

6. The method according to claim 5, wherein the lithium-rich material is LixSi, arid wherein x ranges from 1 to 4.4.

7. The method according to claim 5, wherein the lithium-deficient cathode material is LiyCoO2, and wherein y ranges from 0.5-0.6.

8. The method according to claim 1, wherein the thin film electrochemical energy source is a metal hydride battery, and wherein the anode material is a metal hydride, and the cathode material is a metal oxyhydroxide.

9. The method according to claim 8, wherein he metal hydride is magnesium titanium hydride.

10. The method according to claim 8, wherein the metal oxyhydroxide is nickel oxyhydroxyde.

11. (canceled)

12. An electrical device comprising a thin film electrochemical energy source formed by depositing a first electrode layer on a substrate, depositing an electrolyte layer on the first electrode layer, and depositing a second electrode layer on the electrolyte layer, wherein one of the first electrode layer and the second electrode layer is an anode material and the other electrode layer is a cathode material, the anode material and the cathode material being deposited in a charged state such that a charged battery stack is formed.

13. The electrical device according to claim 12, wherein the thin film electrochemical energy source is integrated in the device.
